(19) United States
(12) Patent Application Publication
(10) Pub. No.: US 2019/0159951 A1
(43) Pub. Date: May 30, 2019

(54) PATIENT CARE ROOM WITH REDUCTION OF SPREAD OF PATHOGENS

(71) Applicant: Innovative Designs for Healthcare, LLC, Cheyenne, WY (US)

(72) Inventors: David L. Hadley, Mesa, AZ (US); Hani A. M. Alhourani, Jeddah (SA)

(21) Appl. No.: 16/251,601

(22) Filed: Jan. 18, 2019

Related U.S. Application Data
(63) Continuation-in-part of application No. 15/249,823, filed on Aug. 29, 2016.
(60) Provisional application No. 62/212,766, filed on Sep. 1, 2015.

(51) Int. Cl. A61G 10/02

(52) U.S. Cl. CPC A61G 10/02

(57) ABSTRACT

A patient care room, and method of treating a patient includes a patient treatment area that is configured to accept a patient support and an airflow system in said patient care room. The airflow system has an air discharge outlet mounted above the patient support. The outlet has a plenum with at least two laterally outside portions that are aligned with opposite perimeters of the patient support. Each outside portion has at least one large opening that is adapted to direct a curtain of air toward the perimeter of the patient support. The plenum has at least one laterally inside portion within the perimeter of the patient support. A cover over the plenum has small openings distributed over the cover that are smaller than the large opening. The outside portions are adapted to each produce a curtain of air that is passed outside a perimeter of the patient support at a higher flow than air inside the perimeter of the patient support.

### CROSS REFERENCE TO RELATED APPLICATION

This application is a continuation-in-part of application Ser. No. 15/249,823 filed Aug. 29, 2016 which claims priority from U.S. patent application Ser. No. 62/212,766, filed on Sep. 1, 2015, the disclosures of which are hereby incorporated herein by reference.

### BACKGROUND AND FIELD OF THE INVENTION

The present invention is directed to a methodology for reducing the spread of infectious disease including airborne pathogens. While the invention is illustrated for use in an intensive care unit of a hospital, it may find use in other hospital settings and in non-hospital patient care facilities.

Recent research has uncovered the fact that airborne bacteria, viruses and other pathogens can remain in a patient's room and survive in the air for several months, and that these airborne contaminants are the result of current everyday nursing practices throughout the world. In an effort to reduce the transmission of infection by contact; hand-washing sinks, and either toilets or clinical sinks, have been recommended and installed in the patient's room. One result of this has been more attention paid to the spread of airborne antibiotic resistant bacteria, which has resulted in the death of many patients.

The sink drains and the aerosol resulting from the hand-washing process and water flow into the drains is a source of infectious airborne bacteria due to the normal airflow that exists in the room. In nearly all patient rooms, the air return registers are located in the ceiling, drawing any airborne bacteria or virus upwards either onto the staff or into the air which is recirculated. Therefore, when the nurse is washing his or her hands after cleaning a patient that may have an infection, the aerosol created in the process of water splashing on the hands gets into the airflow rising upwards and spreads into the air and onto the nurse. Plus, the water flow into the drain creates an aerosol that gets into the airstream.

A source of bacteria transport is foot traffic by health care personnel. In order to clean the floor beneath a patient support such as the bed, it is necessary to move the bed. This is especially difficult in an intensive care unit because the patient is typically connected to a number of monitors and treatment systems, most of which are supported by free-standing supports. Therefore, in order to move the bed, it typically takes up to four (4) persons to move the equipment support poles at the same time as the bed. This produces a significant amount of foot traffic that increases bacterial infectious agents.

### SUMMARY OF THE INVENTION

The present invention provides a patient care room, and method of treating a patient, according to an aspect of the invention, includes a patient treatment area that is configured to accept a patient support and an airflow system in said patient care room. The airflow system has an air discharge outlet mounted above the patient support. The outlet has a plenum with at least two spaced apart laterally outside portions that are aligned with opposite perimeters of the patient support. Each outside portion has a large opening area that is adapted to direct a curtain of air toward the perimeter of the patient support. The plenum has at least one laterally inside portion within the perimeter of the patient support.

A cover may be provided over the plenum having small openings. The small openings may be between approximately 3 millimeters and 4 millimeters. The outside portions are adapted to each produce a curtain of air that is passed outside a perimeter of the patient support at a higher flow than air inside the perimeter of the patient support.

The plenum and cover may both be made from a bacterial resistant fabric. The plenum may have a laterally inside portion between the outside portions having an intermediate opening area that is adapted to direct airflow toward a patient supported by said patient support. The intermediate opening area is smaller than the large opening area. The airflow system may include an air return opposite the patient support. The plenum may have a surface at the large openings that is angled outward and downward toward the patient support. The intermediate opening area provides an air flow directed toward the patient's head that is strong enough to keep airborne bacteria away from the face of the patient, yet not so strong that it may give the patient a chill.

A hand-washing fixture that is configured to wash hands of a treatment practitioner may be provided that include an exhaust exhausting air from said hand-washing fixture outside of the patient room. The exhaust may be at height that is just above the level of the hand-washing fixture.

A soiled material collection bin may be provided that is accessible to the patient care room for depositing soiled material and accessible outside of the patient care room for collecting soiled material. In this manner, soiled material can be deposited without exiting the patient care room and collected without entering the patient care room. The soiled material collection bin may be vented to outside of a building housing the patient care room.

A decentralized supply store may be provided in the patient treatment area for storing supplies needed to treat a patient. In this manner, treatment personnel do not need to leave the patient treatment area to obtain supplies. The supply store may include a supply sensor that determines a need to restock the supply store. The supply sensor may also detect types of items wherein the determining a need to restock the supply store may be according to individual types of items. The room may have a main entry door with the supply store adjacent the room entry door. In this manner, a supply clerk can restock the supply store without entering the patient treatment area.

These and other objects, advantages and features of this invention will become apparent upon review of the following specification in conjunction with the drawings.

### BRIEF DESCRIPTION OF THE DRAWINGS

FIG. 1; is a perspective view illustrating a patient care room according to an embodiment of the invention;

FIG. 2 is a top plan view of the patient care room in FIG. 1;

FIG. 3 is a perspective view illustrating a waste containment room;

FIG. 4a is an elevation view of a soiled material collection bin as seen inside the waste containment room;

FIG. 4b is a sectional view taken along the lines B-B in FIG. 4a;

FIG. 4c is an elevation view of the soiled material collection bin as seen outside the patient room;

FIG. 4d is an elevation view showing exhaust ports at a side of the soiled material collection bin;

FIG. 5 is a perspective view of a hallway outside of the patient care room illustrating the soiled material collection bins;

FIG. 6 is a perspective of an alternative embodiment of a patient care room;

FIG. 7 is a perspective view of an airflow system with the outer layer removed to reveal interior details thereof; and

FIG. 8 is a perspective view of the patient care room in FIG. 6 from an opposite direction thereof; and

FIG. 9 is an elevational view of the plenum shown in FIG. 8.

### DESCRIPTION OF THE PREFERRED EMBODIMENTS

The present invention will now be described with reference to the accompanying figures, wherein the numbered elements in the following written description correspond to like-numbered elements in the figures.

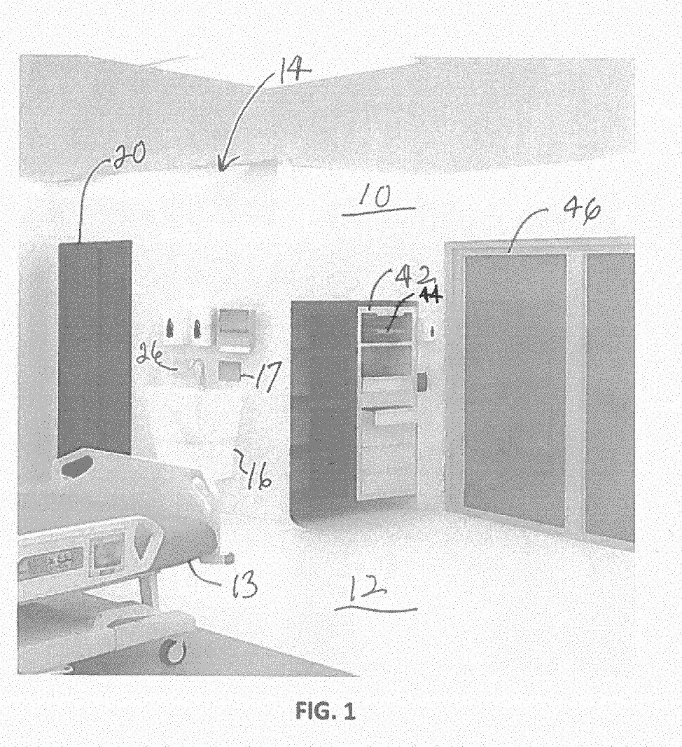

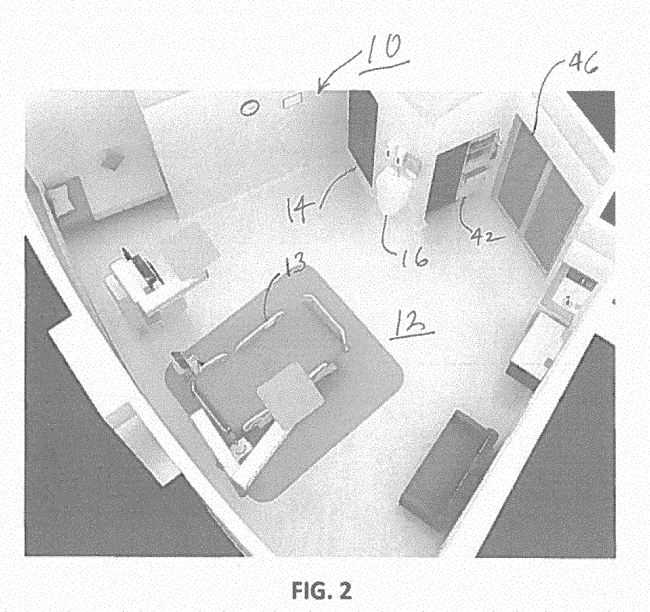

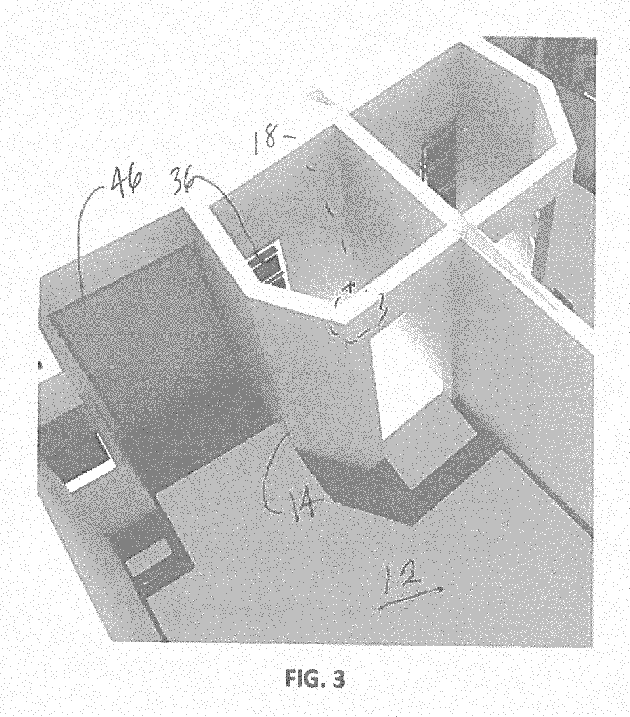

Referring now specifically to the drawings, and the illustrative embodiments depicted therein, a patient care room 10 includes a patient treatment area 12 that is configured to accept a patient support structure, such as a bed 13 (FIGS. 1 and 2). Patient care room 10 includes a waste containment room 14 that is walled from treatment area 12. A hand-washing fixture 16 that is configured to wash hands of a treatment practitioner is mounted in patient treatment area 12, but on a wall dividing the patient treatment area from waste containment room 14. In order to reduce the amount of bacteria laden aerosol going back onto the nurse or other practitioner and into the air of the patient treatment area, the air surrounding washing fixture 16 is exhausted into the waste containment room 14 where it is decontaminated and exhausted from the building.

Waste containment room 14 has a toilet 18 and a door 20 that selectively separates waste containment room 14 from patient treatment area 12. Room 14 may include a waste airflow system 24 that discharges air from waste containment room 14 to outside of the patient care room thereby creating a negative pressure in said waste containment room with respect to the treatment area. The negative pressure will cause any air exchange between the patient treatment area 12 and the waste containment room 14 to flow to the waste containment room not vice versa.

Hand-washing fixture 16 is in the patient treatment area 12 where it is readily accessible but outside of the waste containment room 14. An exhaust 26 exhausts air from hand-washing fixture 16 to waste containment room 14. Exhaust 26 is at height of the hand-washing fixture 16 and immediately adjacent the hand-washing fixture so that any aerosol from the sink drains and the aerosol resulting from the hand-washing process and water flow into the drains will be exhausted away from the practitioner and into the waste treatment room before being inhaled by the practitioner. A waste receptacle 17 may be positioned adjacent exhaust 26. Waste receptacle 17 may terminate in waste containment room 14 so that waste, which may be contaminated, is transferred to the waste containment room without the need to open door 20.

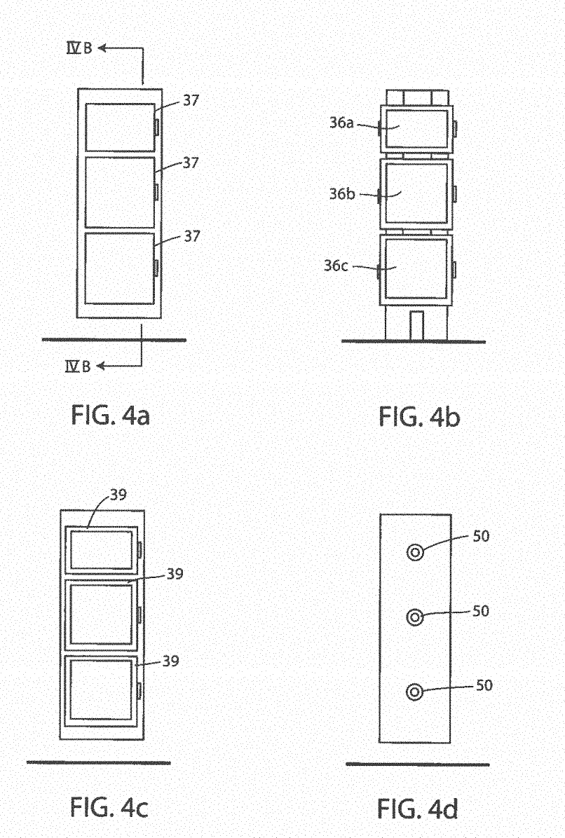

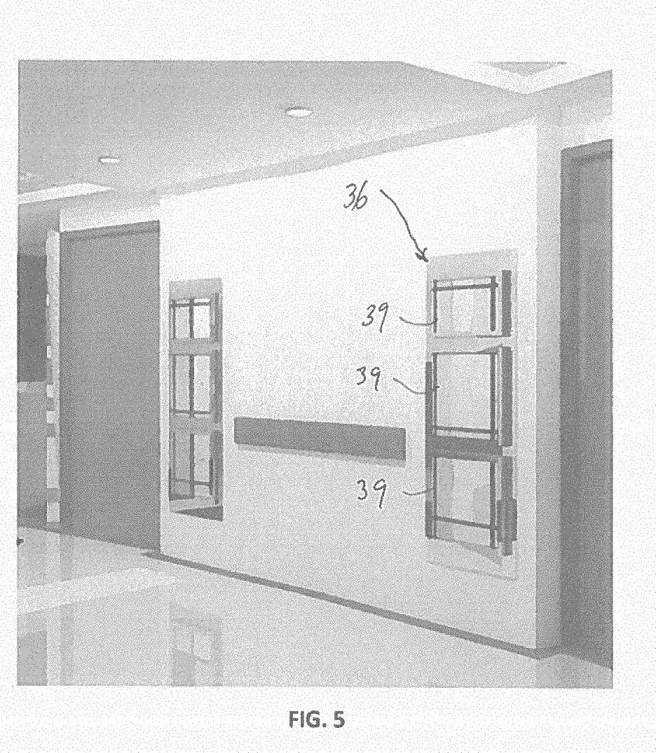

Patient care room 10 includes a soiled material collection bin 36 divided into hatches 36a, 36b, and 36c. Collection bin 36 is accessible to patient care room 10 within or through waste containment room 14 via doors 37, one for each hatch shown in FIG. 4a, for depositing soiled material from the patient care room via the waste containment room. Collection bin 36 is accessible outside of the patient care room via doors 39, one for each hatch, for collecting soiled materials, as best seen in FIG. 5. Doors 39 are outside of patient care room 10 wherein soiled material can be deposited without exiting the patient care room and collected without entering the patient care room. Contact transfer of contaminants is another means of transmitting and transporting infection from one room to another. Soiled material collection bins 36 reduce the transfer of infectious material which may be on soiled linens, patient gowns, diapers, or soiled bandages or pads, whether it be bacteria, fungus, or virus. Bins 36 reduce the traffic of non-clinical personnel, such as housekeeping, within the patient zones. Each waste transfer hatch is also vented via ports 50 to the outside, as seen in FIG. 4d to prevent the build-up of pressure in the hatch which might be a source of contamination to the hallway when opened.

Thus, it can be seen that all waste is collected from the hallway through transfer hatches 36a, 36b and 36c. Therefore, all contaminated linen, waste, and needles or sharp containers are collected in the hallway from its designated compartment, thus avoiding the need for the housekeeping or laundry staff to go from room to room collecting contaminated materials from inside. Keeping the soiled materials in each room's waste containment area which is under negative pressure and being exhausted to the outside of the building reduces the spread of airborne bacteria within the room, and from room to room.

A decentralized supply store 42 in the patient treatment area 12 stores clean supplies needed to treat a patient. Thus, treatment personnel do not need to leave the patient treatment 12 area to obtain supplies from central supply. Supply store 42 includes a supply sensor 44 that senses supplies in supply store 42 to determine a need to restock the supply store. Supply sensor 44 is capable of measuring weight, size, color of items or a bar code or RFID tag in order to detect types of items in order to determine a need to restock the supply store according to individual types of items. Decentralized supply store 42 is adjacent the room entry door 46 so that a supply clerk can restock the supply store without entering the patient treatment area. In addition to allowing supplies to be obtained without needing to leave patient treatment area 12, decentralized supply store 42 may also eliminate a need for a central supply store in each patient ward or nursing floor and thereby better utilize space in the medical facility.

In addition to the above, all furniture in patient care room 10 except the patient's bed is off the floor to ease room cleaning and avoid collection areas where dust laden with bacteria, fungus, or virus can collect. Patient bed 13 is a conventional hospital bed 12 of the type manufactured by Hill Rom, Stryker, or the like, and a patient care system 28 for providing fluid and electrical power to patient life support and monitoring equipment 30 mounted to the bed. Equipment support 32, such as brackets, and the like, are provided for mounting patient life support and monitoring equipment 30 to the bed. The patient life support and monitoring equipment is conventional and may include infusion pumps, patient ventilator, heart monitors, blood pressure monitors respiration monitors, and the like. A bed interface assembly 34 includes a stationary interface assembly 36, and a link 38 and is disclosed in detail in commonly assigned International Publication Number WO2017/037612 entitled hospital equipment interconnection, the disclosure of which is hereby incorporated herein by reference.

Bed interface assembly 34 is adapted to be attached to bed 13 and may have at least one electrical connector for supplying electrical energy to an equipment electrical outlet at least one fluid port or connector for supplying fluid to a patient life support fluid port and data connectors for exchanging signals between bed interface assembly and stationary interface assembly and equipment data connectors for exchanging data with the life support and monitoring equipment. Stationary interface assembly 36 is configured to be positioned at a stationary portion of the room separate from bed 13, such as the room ceiling or other stationary surface.

Link 38 is flexible and connects bed interface assembly 34 and stationary interface assembly 36 and supplies fluids via flexible fluid hoses and electrical power via electrical power lines and data signals between bed interface assembly 34 and stationary interface assembly 36 via signal lines. The link flexibility allows the nursing staff to easily move the patient and their bed, with all life support equipment mounted to the bed, in the event of a liquid spill so that the environment can be maintained clean with minimum human resources. Therefore a portion of the floor under the bed is cleaned by displacing the bed off the portion of the floor while flexing the flexible link, cleaning the portion of the floor and then returning the bed to the portion of the floor, all while supplying fluids and electrical power to the bed interface from the stationary surface through the flexible link. This can be accomplished by as few as 2 persons rather than 4 required for a conventional technique.

Link 38 may also be a separable link. This allows bed 13 to be transported with patient life support and monitoring equipment 60 when the link is separated while substantially continuous communication is maintained between the patient and central communication and nurses station using the technique disclosed in commonly assigned patent application entitled Continuous Communication with Mobile Patient, filed Jan. 16, 2019, Ser. No. 62/793,164 the disclosure of which is hereby incorporated herein by reference.

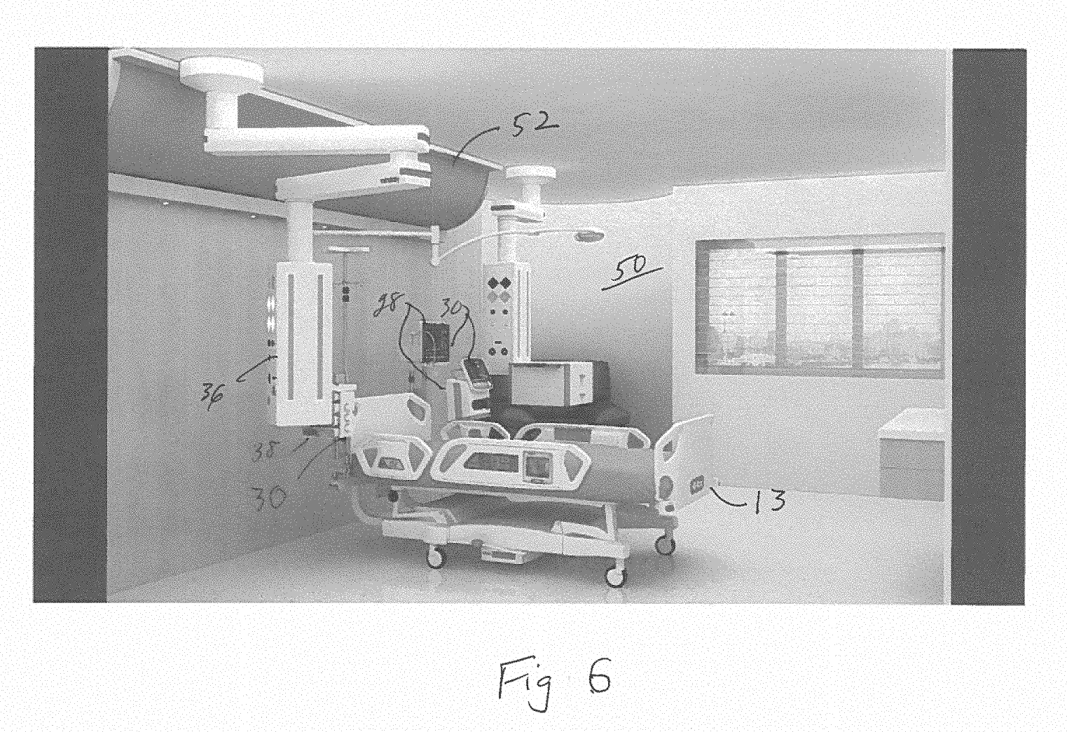

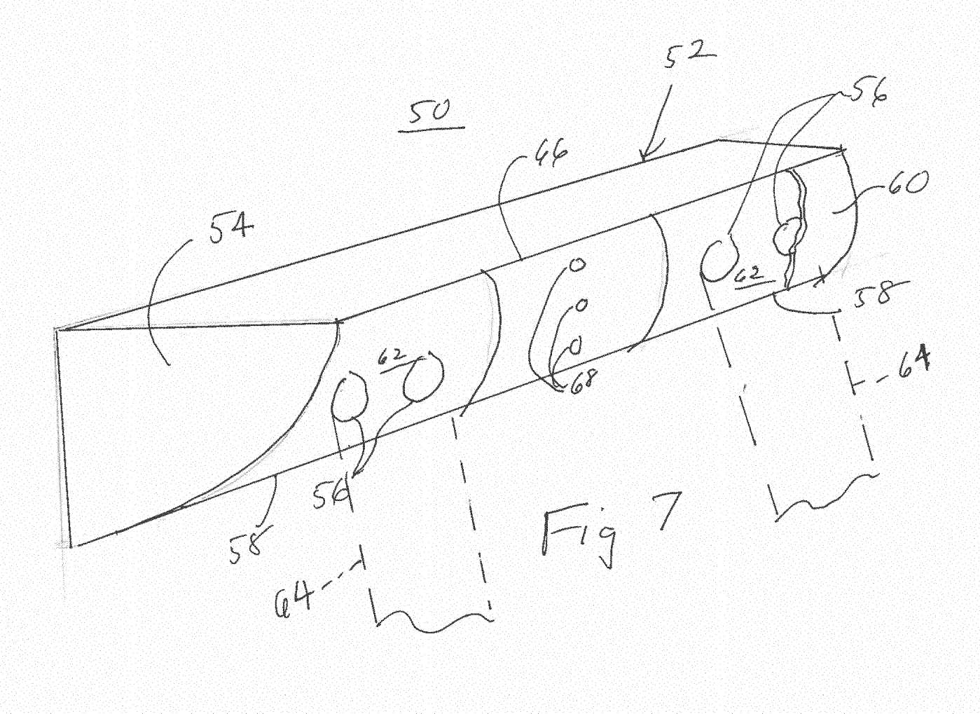

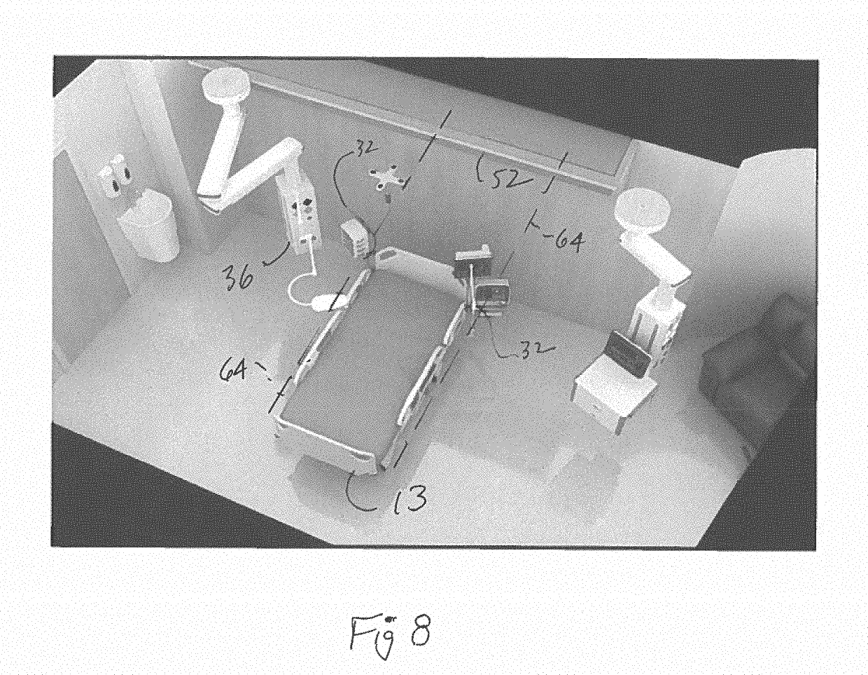

An airflow system 50 may be provided in patient care room 10. The airflow system has an air discharge outlet 52 mounted above the patient support 13 (FIGS. 6-8). The outlet has a plenum 54 with at least two spaced apart laterally outside portions 58 that are aligned with opposite perimeters of the patient support 13. Each outside portion has at least one opening 56 that in combination defines a large opening area that is adapted to direct a curtain of air 64 toward the perimeter of the patient support as best seen in FIG. 8. The plenum has at least one laterally inside portion 66 between the lateral outside portions above the perimeter of the patient support.

A cover 60 over the plenum has small openings distributed over the cover. The openings in cover 60 are sufficient in size to pass air curtains 64. In the illustrated embodiment, the openings in cover 60 are between approximately 3 millimeters and 4 millimeters. At least one intermediate opening 68 is provided on the laterally inside portion 66 of the plenum to direct airflow toward a patient supported by patient support 13. Intermediate openings 68 that define in combination an intermediate opening area that is less than the large opening area. The outside portions 58 are adapted to each produce curtain of air 64 that is passed outside a perimeter of the patient support at a higher flow than air inside the perimeter of the patient support.

Plenum 54 and cover 60 are both made from a bacterial resistant fabric of the type known in the art. Airflow system 50 includes an air return opposite patient support 13. Plenum 54 has a surface 62 at openings 56 that is angled outward and downward directed toward the patient support.

Air curtains 64 helps keep bacteria and the like carried on caregivers and visitors from penetrating the air space of the patient. Intermediate portion 68 provides ventilation to the patient and reduces the tendency from airborne bacteria reaching the patient's face.

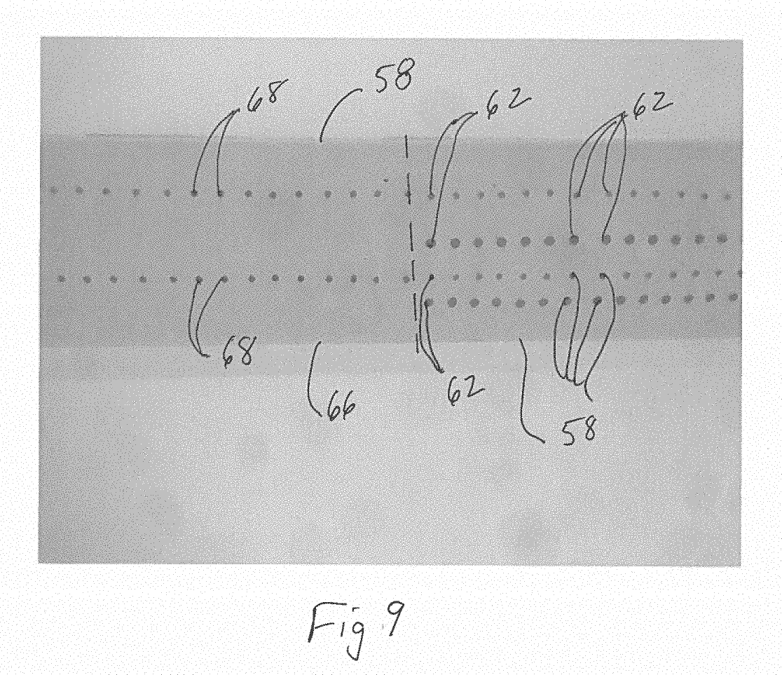

As can be seen in FIG. 9, the overall area of the large opening area can be made larger than that of the intermediate opening area by having more openings and/or larger openings.

The inner textile surface is perforated with larger quantities of holes, and larger sized holes to create a higher pressure on the inner surface of the outer textile at the perimeter of the bed to accelerate the air from the plenum in order to create an air curtain and Coanda Effect at the perimeters of the bed so that air passing over staff or visitors providing attention to the patient hugs the person on the side of the bed and follows a path downward and away from the patient's face. The textile duct area directly above the patient's head is configured differently to create a lower pressure on the outer textile's inner surface by creating smaller holes and fewer holes on the inner textile surface and larger holes on the outer textile surface. This process allows for an increased volume of air at a lower pressure which may then be entrained into the higher pressure air streams at the perimeter of the bed, thus providing a protective air flow of clean HEPA filtered air over the patient's face and upper torso, in a comfortable manner. This air flow tuning process is achieved using a smoke generator in the room and a perforating device for creating holes in the outer textile duct at the locations on the outer textile surface, and with the proper size to achieve the desired effect. The air speed from the adjustable supply duct fan, the room size, the furniture in the room, plus the exhaust and return registers all have an effect on the air flow within the room, and are therefore compensated for using the tuning method mentioned above.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A patient care room, comprising:
a patient treatment area that is configured to accept a patient support;
an airflow system in said patient care room;
said airflow system having an air discharge outlet mounted above said patient support, said outlet having a plenum with at least two laterally spaced apart outside portions outside opposite perimeters of the patient support, each having a large opening area that is adapted to direct a curtain of air toward the perimeter of the patient support and said plenum having at least one laterally inside portion between said outside portions within the perimeter of the patient support.

2. The patient care room as claimed in claim 1 including a cover over said plenum having small openings distributed over said cover that are adapted to pass the curtain of air produced at said laterally spaced apart outside portion.

3. The patient care room as claimed in claim 2 wherein said plenum and said cover are both made from a bacterial resistant fabric.

4. The patient care room as claimed in claim 2 wherein said small openings are between approximately 3 millimeters and 4 millimeters.

5. The patient care room as claimed in claim 1 including an intermediate opening area on a laterally inside portion of said plenum that is adapted to direct airflow toward a patient supported by said patient support, intermediate opening area is smaller than said large opening areas.

6. The patient care room as claimed in claim 1 wherein said airflow system includes an air return opposite said patient support.

7. The patient care room as claimed in claim 1 wherein the plenum has a surface at said large opening area that is angled outward and downward directed toward the patient support.

8. The patient care room as claimed in claim 1 including a hand-washing fixture that is configured to wash hands of a treatment practitioner including an exhaust exhausting air from said hand-washing fixture outside of the patient room.

9. The patient care room as claimed in claim 8 wherein said exhaust is at height of the hand-washing fixture.

10. A patient care room, comprising:
a patient treatment area that is configured to accept a patient support; and
a soiled material collection bin, said collection bin having a selectively closeable opening that is accessible to said patient care room for depositing soiled material and another selectively closeable opening accessible outside of the patient care room for collecting soiled material, wherein soiled material can be deposited without exiting the patient care room and collected without entering the patient care room.

11. The patient care room as claimed in claim 10 wherein said soiled material collection bin is vented to outside of a building housing the patient care room.

12. The patient care room as claimed in claim 10 including a decentralized supply store in the patient treatment area for storing supplies needed to treat a patient whereby treatment personnel do not need to leave the patient treatment area to obtain supplies.

13. The patient care room as claimed in claim 12 wherein said supply store includes a supply sensor, said supply sensor determining a need to restock the supply store.

14. The patient care room as claimed in claim 13 wherein said supply sensor detects types of items wherein said determining a need to restock the supply store is determined according to individual types of items.

15. The patient care room as claimed in claim 12 wherein the room has a main entry door and wherein said supply store is adjacent the room entry door, whereby a supply clerk can restock the supply store without entering the patient treatment area.

16. The patient care room as claimed in claim 10 wherein said patient support comprises a bed.

17. A method of treating a patient in a patient care room, comprising:
said patient care room having a patient treatment area with a floor that is configured to accept a patient support and an airflow system in said patient care room, said airflow system having an air discharge outlet mounted above said patient support, said outlet having a plenum with at least two laterally outside portions positioned in line with opposite perimeters of the patient support;
wherein each of said outside portion passing a curtain of air along the perimeter of the patient support to keep airborne bacteria outside of the patient support.
